(19) United States
(12) Patent Application Publication
(10) Pub. No.: US 2025/0381898 A1
(43) Pub. Date: Dec. 18, 2025

(54) PARTITION DEVICE

(71) Applicant: TOYOTA BOSHOKU KABUSHIKI KAISHA, Aichi-ken (JP)

(72) Inventors: Yuichi SUETSUGU, Aichi-ken (JP); Fumitoshi AKAIKE, Aichi-ken (JP); Takeshi YAMADA, Aichi-ken (JP)

(73) Assignee: TOYOTA BOSHOKU KABUSHIKI KAISHA, Aichi-ken (JP)

(21) Appl. No.: 19/238,830

(22) Filed: Jun. 16, 2025

(30) Foreign Application Priority Data
Jun. 18, 2024 (JP) 2024-097918

(51) Int. Cl. B60N 2/90; B60N 2/879

(52) U.S. Cl. CPC B60N 2/91; B60N 2/879

(57) ABSTRACT

There is provided a partition device including: a panel configured to cover a headrest from a rear side and a lateral side of the headrest, the headrest being attached to an upper portion of a seat back, the panel including a rear panel portion configured to cover the headrest from the rear side and a side panel portion configured to cover the headrest from the lateral side; and a bracket attached to a lower portion of a surface of the rear panel portion facing the headrest. The panel is attachable to a pair of left and right stays of the headrest via the bracket. The side panel portion includes a lower bead formed in a lower portion of the side panel portion and extending substantially horizontally from a position overlapping with or separating from an attachment portion of the bracket.

### CROSS-REFERENCE TO RELATED APPLICATIONS

This application is based on and claims priority under 35 USC 119 from Japanese Patent Application No. 2024-097918 filed on Jun. 18, 2024, the contents of which are incorporated herein by reference.

### TECHNICAL FIELD

The present disclosure relates to a partition device.

### BACKGROUND ART

In the related art, in a vehicle seat such as a driver's seat of a taxi, a partition device for preventing droplets scattered from a rear seat occupant may be attached to a seat back. A partition device described in JP2023-075727A is implemented as a plate-like panel that covers at least a part of a headrest from a rear side and a lateral side.

In the partition device described in JP2023-075727A described above, the plate-like panel is fixed to the headrest via a fastener. Specifically, as illustrated in FIG. 7, for example, a partition device 100 includes a curved panel 101 made of a transparent resin, a reinforcing member 102 that reinforces the panel 101, an attachment member 103 attached to the reinforcing member 102, and a blower device 104. The panel 101 is disposed so as to cover a headrest 106 attached to a seat back 105 from a rear side and a left side. The reinforcing member 102 is a metallic member that is substantially L-shaped when viewed from above, and is attached to a lower portion of the panel 101 on the headrest 106 side so as to extend horizontally. The attachment member 103 is attached to a rear portion of the reinforcing member 102 on the headrest 106 side and is fixed to a pair of left and right stays of the headrest 106. The blower device 104 is attached to the headrest 106 side of the panel 101 and blows air drawn in from a right side toward the left front of a head of a seated occupant P. Since the metallic reinforcing member 102 is attached to the lower portion of the panel 101, the panel 101 can be sufficiently reinforced, but there is a problem in that the weight of the partition device 100 increases due to the presence of the reinforcing member 102.

### SUMMARY OF INVENTION

The present disclosure provides a partition device which is capable of sufficiently ensuring strength and rigidity of a panel without using a reinforcing member or the like which is a separate member.

According to a first aspect of the present disclosure, a partition device includes: a panel configured to cover a headrest from a rear side and a lateral side of the headrest, the headrest being attached to an upper portion of a seat back, the panel including a rear panel portion configured to cover the headrest from the rear side and a side panel portion configured to cover the headrest from the lateral side; and a bracket attached to a lower portion of a surface of the rear panel portion facing the headrest. The panel is attachable to a pair of left and right stays of the headrest via the bracket. The side panel portion includes a lower bead formed in a lower portion of the side panel portion and extending substantially horizontally from a position overlapping with or separating from an attachment portion of the bracket.

According to the first aspect of the present disclosure, the lower bead is formed at the lower portion of the side panel portion and extends substantially horizontally from the bracket from a position overlapping or separating from the attachment portion of the bracket, so that the strength and rigidity of the panel can be sufficiently ensured without using separate members such as reinforcing members. Accordingly, the weight of the partition device can be reduced.

According to a second aspect of the present disclosure, in the partition device of the first aspect, the panel is made of a transparent resin.

According to the second aspect of the present disclosure, in the partition device, no separate members such as reinforcing members are attached to the lower portion of the side panel portion of the panel, and thus the transparency of the panel makes the lateral visibility less likely to be obstructed.

According to a third aspect of the present disclosure, in the partition device of the first or second aspect, the side panel portion includes at least one additional bead formed above the lower bead, the at least one additional bead having a substantially U-shaped cross section and extending substantially parallel to the lower bead.

According to the third aspect of the present disclosure, since at least one additional bead is formed in addition to the lower bead in the side panel portion of the panel, the strength and rigidity of the panel can be more sufficiently ensured.

According to a fourth aspect of the present disclosure, in the partition device of the first or second aspect, the bracket includes: a main body portion formed by bending a metal plate material along a plurality of bending lines parallel to one another; and a stay retaining member fastened and fixed to the main body portion with the pair of left and right stays of the headrest being sandwiched between the main body portion and the stay retaining member.

According to the fourth aspect of the present disclosure, the bracket can have a simple structure.

According to a fifth aspect of the present disclosure, in the partition device of the fourth aspect, the main body portion has a symmetrical shape, and includes one central portion and a pair of left and right side portions disposed on both sides of the central portion. The main body portion allows to be attached to a plurality of the left and right stays having different intervals by changing the central portion.

According to the fifth aspect of the present disclosure, by modifying only the central portion of the main body portion, it becomes possible to attach the main body portion to a plurality of pairs of left and right stays having different intervals, thereby making it possible to reduce the size of replacement parts and reduce the cost of the bracket.

### BRIEF DESCRIPTION OF DRAWINGS

FIG. 1 is a perspective view of a partition device according to an embodiment of the present disclosure, as viewed from a headrest side (inside);

FIG. 2 is a perspective view of the partition device according to the embodiment, as viewed from a side opposite to the headrest (outside);

FIG. 3 is a cross-sectional view taken along a line III-III in FIG. 1;

FIG. 4 is a cross-sectional view taken along a line IV-IV in FIG. 1;

FIG. 5 is an exploded perspective view of a first bracket;

FIG. 6 is an exploded perspective view of a second bracket; and

FIG. 7 is a perspective view of a related partition device as viewed from a seated occupant side (inside).

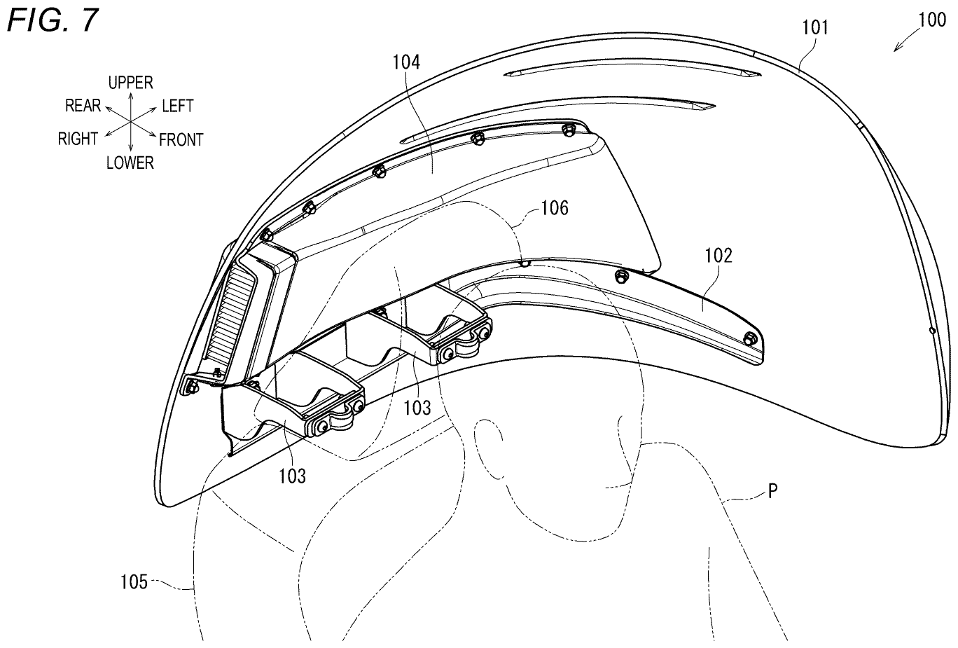

### DESCRIPTION OF EMBODIMENTS

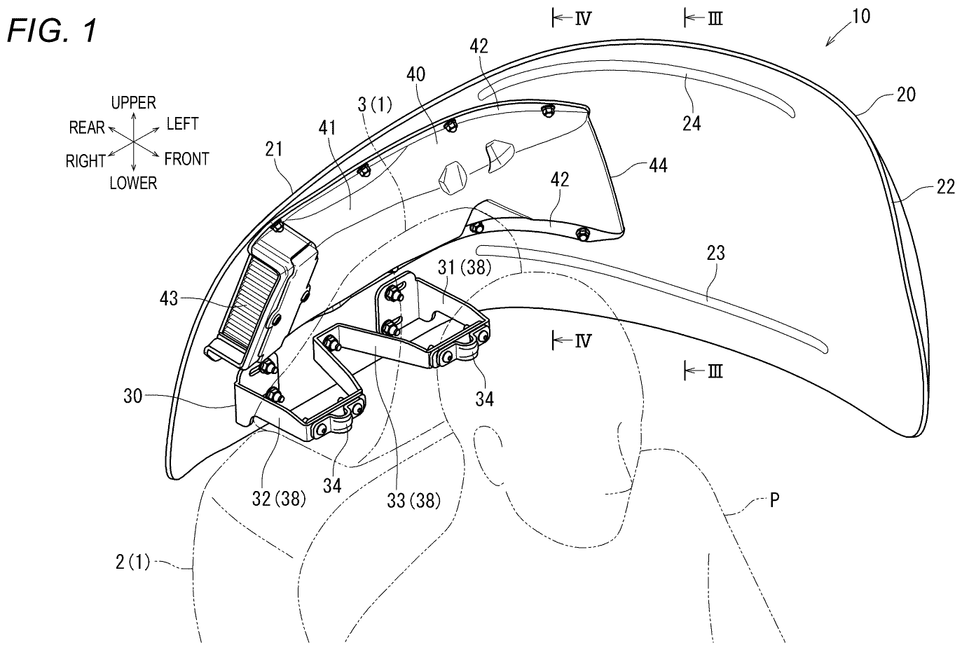

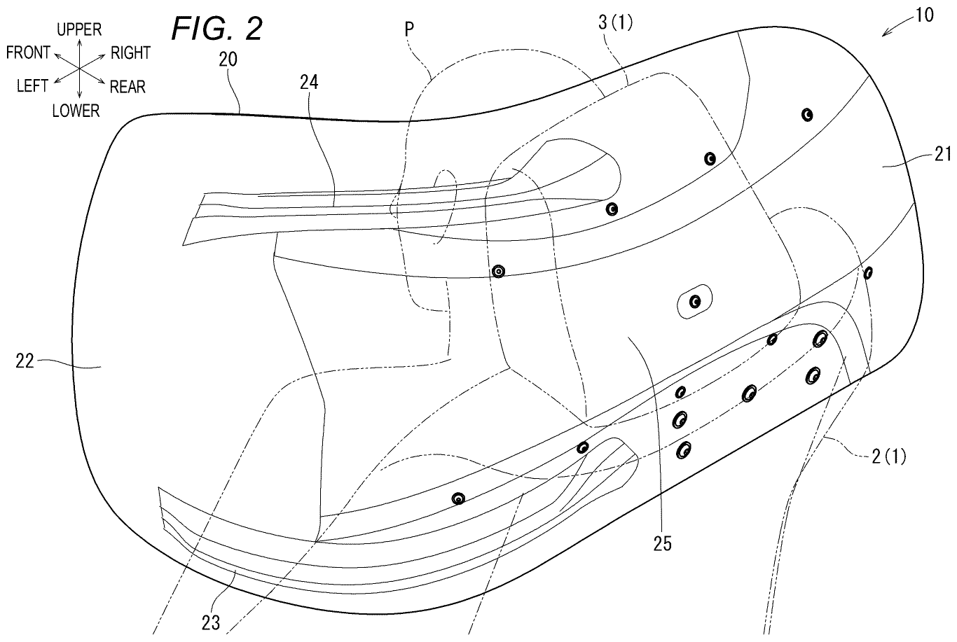

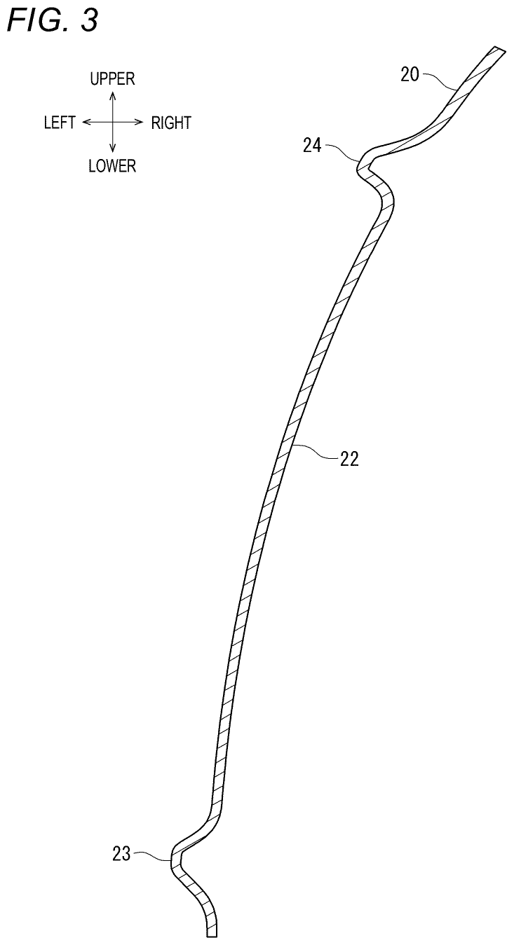

A partition device 10 according to an embodiment of the present disclosure will be described with reference to FIGS. 1 to 6. In the following description, the description of the directions will be made based on the directions of upper, lower, front, rear, left, and right illustrated in the drawings. The directions of upper, lower, front, rear, left, and right are defined based on an automobile seat 1 when the automobile seat 1 to which the partition device 10 is attached is mounted on an automobile.

As illustrated in FIG. 1, the automobile seat 1 includes a seat cushion (not illustrated) that supports buttocks and thighs of a seated occupant P, a seat back 2 that supports a waist and a back of the seated occupant P, and a headrest 3 that supports a head of the seated occupant P.

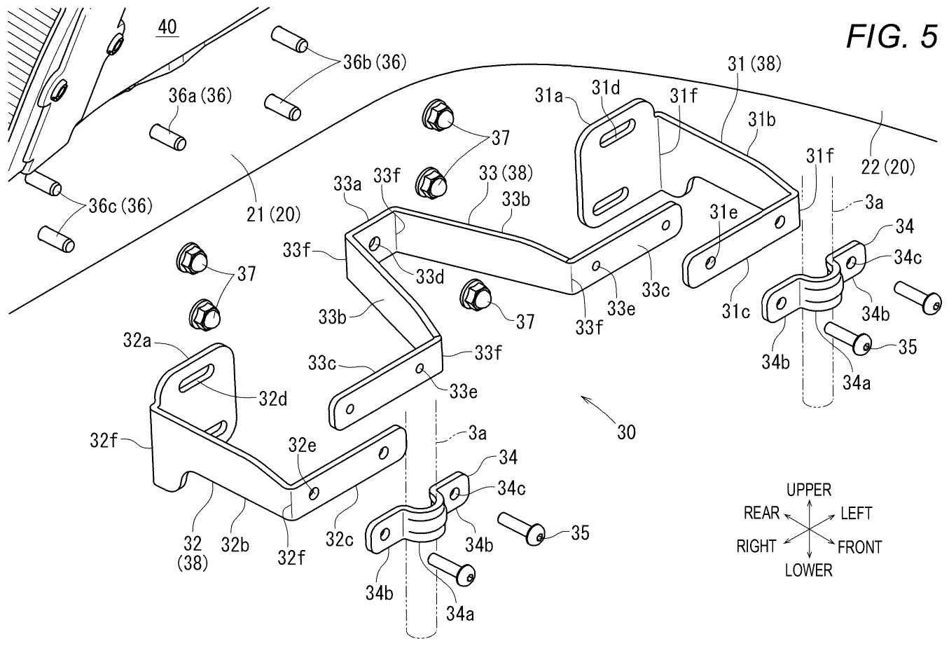

As illustrated in FIGS. 1 and 5, the partition device 10 includes a panel 20 that covers the headrest 3 from a rear side and a left side, a first bracket 30 for attaching the panel 20 to a pair of left and right stays 3a of the headrest 3, and a blower device 40.

As illustrated in FIGS. 1 to 4, the panel 20 is a curved member formed by vacuum molding a plate material made of a transparent polycarbonate resin or an acrylic resin, and includes a rear panel portion 21 that covers the headrest 3 from the rear side, and a side panel portion 22 that covers the headrest 3 from the left side. The rear panel portion 21 and the side panel portion 22 are smoothly connected. A lower bead 23 is formed at a lower portion of the side panel portion 22 and extends substantially horizontally forward from a left end of the rear panel portion 21 to the vicinity of a front end of the side panel portion 22. The lower bead 23 has a substantially U-shaped cross section that opens rightward. An upper bead 24 is formed at an upper portion of the side panel portion 22 and extends substantially horizontally forward from the left end of the rear panel portion 21 to the vicinity of the front end of the side panel portion 22. The upper bead 24 has a substantially U-shaped cross section that opens rightward. A rear end of the lower bead 23 and a rear end of the upper bead 24 are positioned at approximately the same position in a left-right direction, and a front end of the lower bead 23 is positioned slightly forward of a front end of the upper bead 24 in a front-rear direction. A middle bead 25 is formed between the lower bead 23 and the upper bead 24 on a rear end side of the side panel portion 22 and substantially horizontally extends to the rear panel portion 21. The middle bead 25 has a substantially arcuate cross section that opens rightward. A case 41 of a blower device 40, which will be described later, is attached to an inner surface of the middle bead 25, which is a surface on the headrest 3 side. The lower bead 23, the upper bead 24 and the middle bead 25 all contribute to increasing the strength and rigidity of the panel 20. Here, the upper bead 24 and the middle bead 25 may each correspond to the “additional bead” in the claims.

As illustrated in FIGS. 1 and 5, the first bracket 30 is a member formed by bending metal plate materials. The first bracket 30 is formed by connecting a left side member 31, a right side member 32, a central member 33, and two stay retaining members 34 with four screws 35. The left side member 31, the right side member 32, and the central member 33 form a main body portion 38 having a symmetrical shape.

The left side member 31 includes a base plate portion 31a, a vertical plate portion 31b that rises forward from a bending line 31f at a left end of the base plate portion 31a, and a horizontal plate portion 31c that extends rightward and parallel to the base plate portion 31a from the bending line 31f at a front end of the vertical plate portion 31b. Two long holes 31d extending in the left-right direction are formed in the base plate portion 31a in a manner of extending parallel to each other. Two prepared holes 31e aligned in the left-right direction are formed in the horizontal plate portion 31c. The right side member 32 is formed in a symmetrical shape to the left side member 31. That is, the right side member 32 includes a base plate portion 32a, a vertical plate portion 32b that rises forward from a bending line 32f at a right end of the base plate portion 32a, and a horizontal plate portion 32c that extends leftward and parallel to the base plate portion 32a from the bending line 32f at a front end of the vertical plate portion 32b. Two long holes 32d extending in the left-right direction are formed in the base plate portion 32a in a manner of extending parallel to each other. Two prepared holes 32e aligned in the left-right direction are formed in the horizontal plate portion 32c. The central member 33 has a substantially V-shape with an opening facing forward when viewed from above, and includes a central base portion 33a, a pair of left and right slope portions 33b extending forward while being separated from each other from bending lines 33f at left and right ends of the base portion 33a, and a pair of left and right connection portions 33c extending parallel to the base portion 33a in a manner of being separated from each other from the bending line 33f at a front end of each slope portion 33b. A prepared hole 33d is formed in the center of the base portion 33a. Two screw holes 33e aligned in the left-right direction are formed in each connection portion 33c. An interval between the screw holes 33e in the left-right direction is equal to an interval between the two prepared holes 31e in the left-right direction and an interval between the two prepared holes 32e in the left-right direction.

The stay retaining member 34 is a saddle-shaped metal fitting, and includes a retaining portion 34a having a substantially U-shaped horizontal cross section in the center in the left-right direction, and a pair of left and right screw fastening portions 34b extending in the left-right direction and separated from each other from left and right ends of the retaining portion 34a. Each screw fastening portion 34b has a prepared hole 34c formed therein.

As illustrated in FIG. 5, five screws 36 extending forward are arranged on the lower portion of the rear panel portion 21 in the panel 20. The five screws 36 are a central screw 36a arranged in the center in the left-right direction and passed through the prepared hole 33d of the central member 33, two left screws 36b on a left side of the central screw 36a and passed through the long holes 31d of the left side member 31, and two right screws 36c arranged on a right side of the central screw 36a and passed through the long holes 32d of the right side member 32.

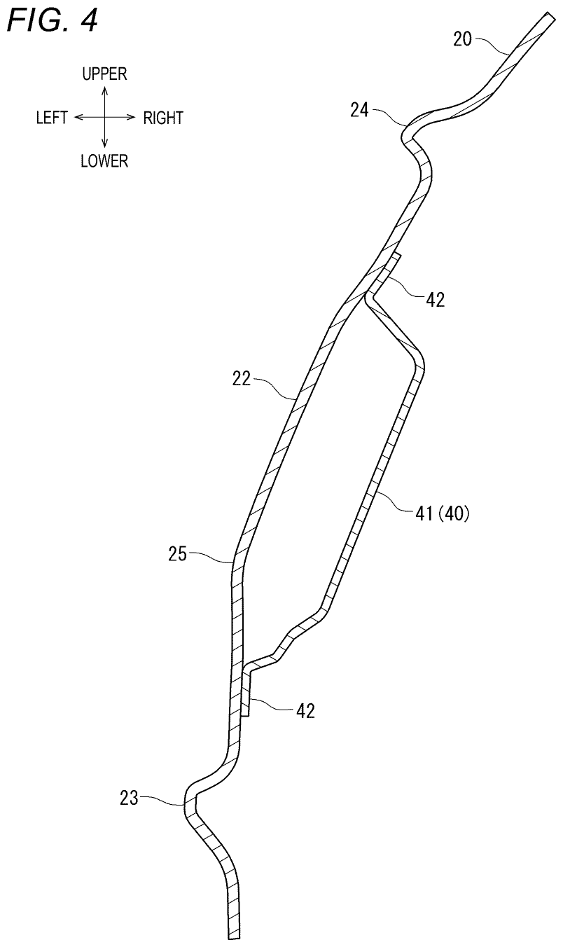

As illustrated in FIGS. 1 and 4, the blower device 40 is attached to the inner surface of the panel 20, which is the surface on the headrest 3 side. The blower device 40 includes a case 41 which is substantially hat-shaped in cross section with an opening toward the panel 20 and extends substantially horizontally so as to straddle from the rear panel portion 21 to the side panel portion 22, and a fan (not illustrated) arranged between the case 41 and the panel 20. The case 41 is positioned so as to overlap the middle bead 25 of the panel 20, and upper and lower flanges 42 are fastened to the panel 20 with screws, thereby contributing to increasing the strength and rigidity of the panel 20 together with the middle bead 25. The blower device 40 draws in air through an intake port 43 at a right end and discharges the air through an exhaust port 44 at a left end by operating the fan. The discharged air flows forward along the inner surface of the panel 20 so as to surround the head of the seated occupant P.

A procedure for attaching the partition device 10 to the automobile seat 1 will be described with reference to FIGS. 1 and 5. The left side member 31, the right side member 32, and the central member 33 of the first bracket 30 are attached to the five screws 36 of the panel 20 to which the air blower device 40 is attached. Specifically, first, the central screw 36a is passed through the prepared hole 33d of the central member 33, and a nut 37 is tightened to fix the central member 33 to the panel 20. Next, with the left screws 36b passed through the long holes 31d of the left side member 31, respectively, the two screw holes 33e of the central member 33 and the two prepared holes 31e of the left side member 31 are aligned so that the prepared holes 31e are on the front side, and the nuts 37 are respectively tightened onto the left screws 36b to fix the left side member 31 to the panel 20. Subsequently, with the right screws 36c passed through the long holes 32d of the right side member 32, respectively, the two screw holes 33e of the central member 33 and the two prepared holes 32e of the right side member 32 are aligned so that the prepared holes 32e are on the front side, and the nuts 37 are respectively tightened onto the left screws 36b to fix the right side member 32 to the panel 20. In this state, a front surface of the horizontal plate portion 31c of the left side member 31 is brought into contact with the left stay of the pair of left and right stays 3a of the headrest 3 from the rear side, and the stay retaining member 34 is placed against the left stay from the front side so that the left stay fits into the retaining portion 34a, and the screws 35 are fastened and fixed to the connection portion 33c of the central member 33. Specifically, the screws 35 that respectively pass through the prepared holes 31e of the horizontal plate portion 31c and the prepared holes 34c of the stay retaining member 34 are respectively fastened and fixed to the screw holes 33e of the connection portion 33c. Similarly, a front surface of the horizontal plate portion 32c of the right side member 32 is brought into contact with the right stay of the pair of left and right stays 3a of the headrest 3 from the rear side, and the stay retaining member 34 is placed against the right stay from the front side so that the right stay fits into the retaining portion 34a, and the screws 35 are fastened and fixed to the connection portion 33c of the central member 33. Specifically, the screws 35 that respectively pass through the prepared holes 32e of the horizontal plate portion 32c and the prepared holes 34c of the stay retaining member 34 are respectively fastened and fixed to the screw holes 33e of the connection portion 33c.

The present embodiment configured as described above has the following effects. The lower bead 23 having an approximately U-shaped cross section that opens toward the headrest 3 side is formed at the lower portion of the side panel portion 22 of the panel 20 and extends substantially horizontally from the first bracket 30, so that the strength and rigidity of the panel 20 can be sufficiently ensured without using separate members such as reinforcing members. Accordingly, the weight of the partition device 10 can be reduced.

The panel 20 is made of a transparent resin. Since no separate members such as reinforcing members are attached to the lower portion of the side panel portion 22 of the panel 20, the transparency of the panel 20 makes the lateral visibility of the seated occupant P less likely to be obstructed. Further, since the upper bead 24 and the middle bead 25 are formed on the side panel portion 22 of the panel 20 above the lower bead 23 and extend substantially parallel to the lower bead 23, the strength and rigidity of the panel 20 can be more sufficiently ensured. In addition, the lower bead 23, the upper bead 24, and the middle bead 25 all have a substantially U-shaped cross section that opens toward the headrest 3 side and are arranged substantially parallel to each other, so that the flow of conditioned air supplied from the front of the automobile seat 1 can be smoothly guided rearward, thereby suppressing a decrease in comfort in the rear seats. In addition, the first bracket 30 includes the main body portion 38 formed by bending metal plate materials along a plurality of parallel bending lines 31f, 32f, and 33f, and stay retaining members 34 that are fastened and fixed to the main body portion 38 with the pair of left and right stays 3a of the headrest 3 sandwiched between the main body portion 38 and the stay retaining member 34, respectively. This allows the first bracket 30 to have a simple structure.

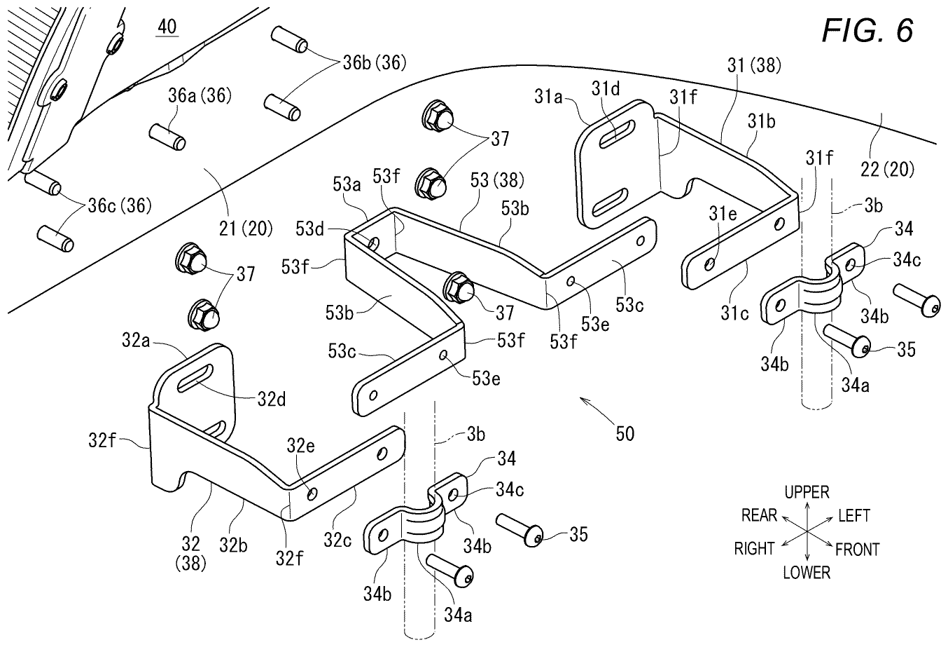

FIG. 6 illustrates another embodiment. The difference from the above embodiment is that a central member 53 of a second bracket 50 is different from the central member 33 of the first bracket 30 according to the above embodiment. Components common to those of the above embodiment are denoted by the same reference numerals, and description thereof is omitted. Specifically, slope portions 53b of the central member 53 in the second bracket 50 are different from the slope portions 33b of the central member 33 in the first bracket 30 in that the rising direction of the slope portion 53b is closer to the front-rear direction. In other words, the degree to which the pair of left and right slope portions 53b gradually separate forward from the bending lines 53f at the left and right ends of a base portion 53a is formed to be smaller than the degree to which the pair of left and right slope portions 33b gradually separate forward. A dimension between a pair of left and right connection portions 53c is smaller than a dimension between the pair of left and right connection portions 33c. Accordingly, the second bracket 50 is applied to a pair of left and right stays 3b of the headrest 3 which have a narrower interval between the stays than the pair of left and right stays 3a of the headrest 3 to which the first bracket 30 is applied. At this time, the interval between the left side member 31 and the right side member 32 in the second bracket 50 is narrower than that in the first bracket 30, but since two long holes 31d extending in the left-right direction are formed in the base plate portion 31a, and two long holes 32d extending in the left-right direction are formed in the base plate portion 32a, the second bracket 50 can be attached to the panel 20 without any problems. Here, the first bracket 30 and the second bracket 50 may each correspond to the “bracket” in the claims.

Although a specific embodiment has been described above, the present disclosure is not limited to the appearance and configuration thereof, and various modifications, addition, and deletion can be made without changing the gist of the present disclosure. Examples thereof include the following.
1. In the embodiments described above, in the lower portion of the side panel portion 22, the lower bead 23 extends substantially horizontally forward from the left end of the rear panel portion 21 to the vicinity of the front end of the side panel portion 22. However, the present disclosure is not limited thereto, and the rear end of the lower bead 23 may be disposed so as to overlap a part of the rear panel portion 21.
2. Although the present disclosure is applied to the automobile seat 1, the present disclosure may also be applied to seats for airplanes, ships, railway cars, and the like.

What is claimed is:

1. A partition device, comprising:
a panel configured to cover a headrest from a rear side and a lateral side of the headrest, the headrest being attached to an upper portion of a seat back, the panel including a rear panel portion configured to cover the headrest from the rear side and a side panel portion configured to cover the headrest from the lateral side; and
a bracket attached to a lower portion of a surface of the rear panel portion facing the headrest, wherein
the panel is attachable to a pair of left and right stays of the headrest via the bracket, and
the side panel portion includes a lower bead formed in a lower portion of the side panel portion and extending substantially horizontally from a position overlapping with or separating from an attachment portion of the bracket.

2. The partition device according to claim 1, wherein
the panel is made of a transparent resin.

3. The partition device according to claim 1, wherein
the side panel portion includes at least one additional bead formed above the lower bead, the at least one additional bead having a substantially U-shaped cross section and extending substantially parallel to the lower bead.

4. The partition device according to claim 1, wherein
the bracket includes: a main body portion formed by bending a metal plate material along a plurality of bending lines parallel to one another; and a stay retaining member fastened and fixed to the main body portion with the pair of left and right stays of the headrest being sandwiched between the main body portion and the stay retaining member.

5. The partition device according to claim 4, wherein
the main body portion has a symmetrical shape, and includes one central portion and a pair of left and right side portions disposed on both sides of the central portion, and
the main body portion allows to be attached to a plurality of the left and right stays having different intervals by changing the central portion.

6. The partition device according to claim 1, wherein
the lower bead has a cross-sectional shape that opens toward the headrest over the entire length of the lower bead.

7. The partition device according to claim 3, wherein
the additional bead has a cross-sectional shape that opens toward the headrest over the entire length of the lower bead.
